(19) United States
(12) Patent Application Publication
(10) Pub. No.: US 2022/0406556 A1
(43) Pub. Date: Dec. 22, 2022

(54) ELECTRON SOURCE FOR GENERATING AN ELECTRON BEAM

(71) Applicant: FRIEDRICH-ALEXANDER-UNIVERSITÄT ERLANGEN-NÜRNBERG, Erlangen (DE)

(72) Inventors: Heiko Weber, Erlangen (DE); Michael Krieger, Röthenbach (DE); Christian Ott, Fürth (DE)

(21) Appl. No.: 17/638,891

(22) PCT Filed: Jul. 31, 2020
(86) PCT No.: PCT/EP2020/071704

§ 371 Date: Feb. 28, 2022

(30) Foreign Application Priority Data
Aug. 29, 2019 (DE) 10 2019 123 248.1

(51) Int. Cl. H01J 35/06

(52) U.S. Cl. CPC H01J 35/064; H01J 35/066

(57) ABSTRACT

An electron source (2) for generating an electron beam (8) having a cathode (1) and an anode (4) in the form of a graphene layer (6, 12) epitaxially grown on a silicon carbide substrate (5). The invention is suitable for monolithic preparation of a miniaturized source of a high-energy focused electron beam, including its use as an on-chip X-ray source. All components can be prepared from or on a single silicon carbide chip.

### FIELD OF THE INVENTION

The invention relates to an electron source for generating an electron beam. Furthermore, the invention relates to a method for generating an electron beam.

### BACKGROUND OF THE INVENTION

Electron sources are used, among others, in electron microscopy and for generating X-rays. In electron microscopy in particular, a point source of high brilliance and low energy dispersion is required; at the same time, high stability and longevity are desirable under vacuum conditions that are as non-critical as possible.

Thermal emitters with low brilliance but simple structure are known from the prior art. Also known are single-crystalline tungsten or LaB6 field-effect emitters, which have high brilliance but extreme vacuum requirements due to ion bombardment and can only be operated stably over short periods of time. Finally, so-called Schottky emitters are known, which are operated at high temperatures and represent a reasonable compromise between field-effect emitters and the more stable thermal emitters. However, Schottky emitters are expensive, they usually have to be selected manually and require complex adjustment during installation; moreover, their durability is limited between one and a few years.

An up-to-date assessment of the different types of sources is given in X. Shao, A. Srinivasan, W. K. Ang, A. Khursheed, A high-brightness large-diameter graphene coated point cathode field emission electron source, Nature communications, 9 (2018) 1288. This paper also discloses a field-effect emitter featuring a cathode made of graphene-coated nickel.

The manufacture of known electron sources can be disadvantageously costly. Also, for known electron sources, the size of the required assembly space may be disadvantageous. In particular, it may be disadvantageous for known electron sources that the cathode and the means for extracting electrons from the cathode form discrete assemblies. Similarly, in known electron sources featuring electron optics, post-acceleration and/or electronic control, it may be disadvantageous that these assemblies are formed as discrete assemblies to the assembly(ies) of the cathode and/or the means for extracting electrons.

### The Object Underlying the Invention

The object of the invention is to provide an improved electron source for generating an electron beam. Furthermore, the object of the invention is to provide an improved method for generating an electron beam. In particular, the invention is intended to overcome disadvantages of electron sources and methods for generating an electron beam known from the prior art.

### Solution According to the Invention

The reference numbers in all claims have no limiting effect but only serve the purpose of improving their readability.

The solution of the set task succeeds using an electron source with the features of claim 1. The electron source according to the invention features a cathode with a substrate comprising silicon carbide. In the sense of the present invention, the substrate of a component (for example, the cathode) of the electron source is a material on which the component (and possibly other components) is firmly disposed directly (in the sense that the component is in direct mechanical connection with the substrate) or indirectly (in the sense that the component is in mechanical connection with the substrate by means of another component or another material).

Silicon carbide in the sense of the present invention may have defects and/or be doped with foreign atoms. It may be monocrystalline or polycrystalline.

This aspect of the invention can take advantage of the fact that silicon carbide has a good high withstand voltage. It can also take advantage of the fact that processes are available to manufacture silicon carbide on an industrial scale. Finally, it can be advantageously achieved with silicon carbide that surface currents play only a subordinate role at electrical potential differences of a few kilovolts, such as those required for an electron source.

With the invention, it can be advantageously achieved that several components of the electron source can be arranged on a common silicon carbide-enclosing substrate, which can result in higher integration. This can simplify the manufacture of the electron source according to the invention. Also, a miniaturization, i.e. a reduction of the installation space required for the electron source, can be advantageously achieved. In particular, an on-chip electron source can be realized with the invention.

With the invention, it can also be advantageously achieved that one or more components of the electron source can be arranged with other electronic, mechanical or mechatronic components on a common silicon carbide-enclosing substrate, which can also result in a higher level of integration. This can simplify the manufacture of devices comprising an electron source. Also, a miniaturization, i.e. a reduction of the installation space required for a device comprising an electron source, can be advantageously achieved. In particular, an on-chip device comprising an electron source can be realized with the invention.

Furthermore, the solution of the problem according to the invention succeeds by an electron source for generating an electron beam, which comprises an anode featuring a graphene layer.

A graphene layer in the sense of the present invention is a graphene monolayer or a graphene multilayer with at most 100 superimposed graphene monolayers. In this context, a graphene monolayer refers to a single layer of carbon atoms arranged in a hexagonal lattice. A graphene monolayer according to the invention may be—locally or completely—chemically modified, have lattice distortions and/or defects and/or be doped with foreign atoms. A fully or partially oxidized graphene layer is also a graphene layer in the sense of the present invention. However, the preferred graphene layer is not or only partially oxidized or chemically modified. A multilayer graphene layer according to the invention preferably has less than 50 monolayers, particularly preferably less than 15 monolayers, particularly preferably less than 4, preferably less than 3 monolayers.

This aspect of the invention can take advantage of the fact that graphene is one of the materials with particularly high allowable current densities. The invention can also benefit from the fact that graphene is exceptionally robust.

The solution of the task is also achieved by a method for generating an electron beam having the features of claim 15. In the method according to the invention, electrons are emitted from a cathode featuring a substrate comprising silicon carbide. Alternatively or additionally, electrons are accelerated to an anode comprising a graphene layer.

The invention is suitable for monolithic preparation of a miniaturized source of a high-energy focused electron beam, including its use as an on-chip X-ray source. All components of the electron source according to the invention can be prepared from or on a single silicon carbide chip.

### PREFERRED EMBODIMENTS OF THE INVENTION

Advantageous embodiments and further developments, which can be used individually or in combination with each other, are the subject of the dependent claims and the following description.

Particularly preferably, the substrate consists mainly, particularly preferably entirely of silicon carbide. The preferred silicon carbide of the invention is one of the polytypes 4H—SiC and 6H—SiC.

The preferred cathode comprises a graphene layer, preferably the cathode consists of one or more graphene layers. The preferred graphene layer(s) of the cathode is/are in contact with the silicon carbide of the substrate. The graphene layer of the cathode is preferably epitaxially grown with the silicon carbide, for example by thermal decomposition. A suitable method for fabricating epitaxial graphene based on silicon carbide is known from K. V. Emtsev, A. Bostwick, K. Horn, J. Jobst, G. L. Kellogg, L. Ley, J. L. McChesney, T. Ohta, S. A. Reshanov, J. Rohrl, E. Rotenberg, A. K. Schmid, D. Waldmann, H. B. Weber, T. Seyller, Towards wafer-size graphene layers by atmospheric pressure graphitization of silicon carbide, Nat Mater, 8 (2009) 203-207 and known from Hertel, F. Kisslinger, J. Jobst, D. Waldmann, M. Krieger, H. B. Weber, Current annealing and electrical breakdown of epitaxial graphene, Applied Physics Letters, 98 (2011) 212109.

The methods described there are also applicable in an analogous way to 4H—SiC.

Epitaxial graphene, in particular that on silicon carbide, can advantageously permit particularly high current densities and be exceptionally robust. This can be exploited by the invention to achieve high currents or to withstand oppositely accelerated parasitic ion bombardment and thus enable a stable operation of the electron source according to the invention.

The preferred electron source features an anode. It also preferably has an acceleration track between the cathode and the anode to extract electrons from the cathode based on an electrical potential difference, also referred to as an extraction voltage, between the cathode and the anode and to accelerate electrons from the cathode towards the anode. In a preferred embodiment of the invention, the potential difference is greater than 100 V (volts), preferably greater than 300 V, particularly preferably greater than 1 kV (kilovolts), particularly preferably greater than 9 kV, particularly preferably greater than 15 kV. The potential difference is preferably less than 40 kV, particularly preferably less than 30 kV, particularly preferably less than 25 kV, for example 20 kV. This embodiment of the invention is particularly suitable for an electron source for generating X-rays. In a preferred embodiment of the invention, the potential difference is greater than 90 kV, preferably greater than 200 kV, particularly preferably greater than 350 kV. The potential difference is preferably less than 1 500 kV, particularly preferably less than 800 kV, for example 400 kV. This embodiment of the invention is particularly suitable for generating high-energy electron beams.

The preferred anode comprises a graphene layer, the anode preferably consists of one or more graphene layers. The preferred anode has a substrate featuring silicon carbide. The preferred graphene layer(s) of the anode is/are in contact with the silicon carbide of the substrate. The graphene layer of the anode is preferably epitaxially grown with the silicon carbide of the substrate, for example by thermal decomposition.

The preferred anode is a perforated anode in the sense that it has a channel playing the role of the hole of the perforated anode. Graphene layer(s) adjoin(s) the channel, preferably on opposite sides of the channel. The channel may be open or closed at the end facing away from the cathode. In a preferred embodiment, the perforated anode comprises two graphene layers, particularly preferably lying in a common plane. Edges of the graphene layers facing each other form the channel of the perforated anode, which is open on both sides.

The preferred channel comprises a groove in the substrate extending in the longitudinal direction of the channel. The graphene layer(s) of the anode is/are preferably arranged on the areas of the substrate adjacent to the channel, directly or indirectly.

The preferred substrate comprises or consists of silicon carbide. The preferred substrate is structured, doped and/or metallized in order to deflect undesired components of the electron beam or to counteract static charging or even to prevent it completely.

The cathode and the anode are preferably arranged on the same substrate, which features or consists of silicon carbide. Advantageous use can be made of the fact that the silicon carbide, in particular also in combination with epitaxial graphene, feature a high breakdown field strength and low leakage currents.

In one embodiment of the anode, it comprises a second substrate, which preferably also features or consists of silicon carbide and may be structured, doped and/or metallized. This substrate, too, preferably carries a graphene layer, wherein particularly preferably the surfaces of the graphene layer(s) of the first and the second substrate face each other to form a channel for the electron beam therebetween. Particularly preferably, the second substrate extends across the cathode. Particularly preferably, the second substrate extends across the acceleration track between anode and cathode. Particularly preferably, the second substrate extends across the entire electron source.

A further structure may be provided between the cathode and anode which is constructed in accordance with one of the embodiments of the anode described above. During operation, this can be kept at a negative potential with respect to the cathode, thus performing a function of a conventional Wehnelt cylinder.

In a preferred electron source, the graphene layer of the cathode is arranged such that electrons are emitted at an edge of the graphene layer of the cathode to be accelerated towards the anode. In doing so, the graphene layer preferably lies epitaxially on a pedestal of the substrate of the cathode. The edge preferably faces the anode of the electron source.

A preferred graphene layer of the cathode is formed as a strip. The width of the preferred strip is less than 300 nm (nanometers), particularly preferably less than 100 nm, particularly preferably less than 30 nm, particularly preferably less than 10 nm. Suitable strips and a suitable preparation method are for example known from M. Sprinkle, M. Ruan, Y. Hu, J. Hankinson, M. Rubio-Roy, B. Zhang, X. Wu, C. Berger, W. A. de Heer, Scalable templated growth of graphene nanoribbons on SiC, Nature nanotechnology, 5 (2010) 727-731. Special features of graphene growth on silicon carbide surfaces can be exploited. Current flow preferably occurs in the longitudinal direction of the graphene strip when the electron source is operated. Electron emission occurs at the edge of a narrow side of the strip. The emitting edge is preferably less than 300 nm, particularly preferably less than 100 nm, particularly preferably less than 30 nm, particularly preferably less than 10 nm wide. In one embodiment of the invention, the cathode comprises not only one, but two or more strips. The preferred strips are arranged in parallel.

The graphene of the preferred graphene layer of the cathode is chemically functionalized at the edge of the graphene layer emitting the electrons of the electron beam, for example by carboxyl groups, fluorine or oxidation with oxygen.

As a result, this can advantageously narrow the energy distribution of the electrons and/or improve the stability of the emitting edge. In one embodiment of the invention, the cathode graphene layer is divided at its emitting edge in its longitudinal direction into a plurality of sections, one or more of which are non-functionalized and another section or other sections are functionalized, or one or more of which are functionalized differently than another section or other sections. For example, a non-functionalized section may be bounded on either side by functionalized, for example oxidized, sections. With this embodiment of the invention, a narrowing of the emitting area of the emitting edge is achievable.

The preferred cathode has a graphene-graphene tunnel contact or a graphene-graphene nanobridge. A tunnel contact in the sense of the present invention is formed by two opposing electrodes which have their smallest distance in the area of the tunnel contact, this distance being less than 1 nm. A nanobridge in the sense of the present invention is formed by two electrodes connected to one another by a bridge, the bridge being less than 100 nm wide at its narrowest point, particularly preferably less than 10 nm wide, particularly preferably less than 1 nm wide. The graphene-graphene tunnel contact or the graphene-graphene nanobridge is constructed and arranged such that electrons are emitted from the surroundings of the graphene-graphene tunnel contact or a graphene-graphene nanobridge.

The electrons are preferably emitted in the direct surroundings of the graphene-graphene tunnel contact or the graphene-graphene nanobridge. This embodiment of the invention is based, among others, on the realization that in the case of a graphene-graphene tunnel contact and a graphene-graphene nanobridge, a spatially confined electron plasma (also referred to as nanoplasma) can be formed above the positive electrode. It is therefore particularly preferred that the cathode emits electrons from this plasma.

Advantageously, the technique of electron emission in the area of a graphene-graphene tunnel contact or a graphene-graphene nanobridge can avoid the possibility of a parasitic, backward ion bombardment directly impinging on and damaging a solid-state tip. Instead, it is achievable that the ion bombardment grazes past the cathode material. With a cathode according to this embodiment of the invention, a large dynamic range of possible emission currents, excellent long-term stability, as well as fast on/off times in the nanosecond range are also advantageously achievable.

According to the invention, the electrons emitted in the area of the graphene-graphene tunnel contact or the graphene-graphene nanobridge can be accelerated towards the anode. The preferred graphene-graphene tunnel contact or the preferred graphene-graphene nanobridge face the anode for this purpose.

In one embodiment of the invention, the cathode comprises one or more carbon nanotube(s). Electrons are preferably emitted from the carbon nanotube(s) to be accelerated towards the anode. The preferred nanotube(s) is or are located at the emitting edge of the graphene layer or the graphene layers of the cathode. For this purpose, it is preferable that the carbon nanotube(s) is/are synthesized at the edge of the graphene layer(s). A suitable method for this is known, for example, from J. R. Sanchez-Valencia, T. Dienel, O. Gröning, I. Shorubalko, A. Mueller, M. Jansen, K. Amsharov, P. Ruffieux, R. Fasel, Controlled synthesis of single-chirality carbon nanotubes, Nature, 512 (2014) 61.

Advantageously, the carbon nanotube(s) allows to obtain a geometrical narrowing of the emission site of the electrons at the cathode.

A carbon nanotube in the sense of the present invention comprises single-walled as well as multi-walled carbon nanotubes. A carbon nanotube may be open on both sides, open on one side, or closed on both sides. Also, carbon nanorolls, i.e. wound single or multilayer graphene layers, fall under the concept of carbon nanotubes for the purpose of the present invention. A carbon nanotube according to the invention may be—locally or completely—chemically modified, feature lattice distortions and/or defects and/or be doped with foreign atoms. A fully or partially oxidized carbon nanotube is also a carbon nanotube in the sense of the present invention. However, the preferred carbon nanotube is not or only partially oxidized or otherwise chemically modified. The wall of a multi-walled carbon nanotube according to the present invention preferably features less than 8, particularly preferably less than 4, layers of carbon atoms arranged in a hexagonal lattice.

In a preferred embodiment of the invention, the end of the nanotube according to the invention facing away from the cathode is semiconducting or metallic.

A preferred electron source comprises electron optics, for example an electrostatic lens for focusing the electron beam. The electron optics preferably comprises a substrate featuring a graphene layer, particularly preferably epitaxially grown, and/or a metallization. The substrate preferably comprises silicon carbide or consists thereof. The preferred electron optics is disposed on the same substrate as the cathode and/or the anode.

The electron source according to the invention may feature a dielectric resonance structure to accelerate the electrons of the electron beam. Suitable resonant structures are known, for example, from R. J. England, R. J. Noble, K. Bane, D. H. Dowell, C.-K. Ng, J. E. Spencer, S. Tantawi, Z. Wu, R. L. Byer, E. Peralta, K. Soong, C.-M. Chang, B. Montazeri, S. J. Wolf, B. Cowan, J. Dawson, W. Gai, P. Hommelhoff, Y.-.C. Huang, C. Jing, C. McGuinness, R. B. Palmer, B. Naranjo, J. Rosenzweig, G. Travish, A. Mizrahi, L. Schachter, C. Sears, G. R. Werner, R. B. Yoder, Dielectric laser accelerators, Reviews of Modern Physics, 86 (2014) 1337-1389. A resonant structure can be used to post-accelerate the electrons of the electron beam, for example, to generate high-energy electrons. Suitable applications for such high-energy electron beams comprise microchip electron beam generation for medical applications, a compact particle accelerator, an on-chip synchrotron, and compact electron microscopy. The resonant structure preferably comprises a substrate comprising or consisting of silicon carbide. The substrate preferably comprises silicon carbide or consists thereof. The preferred resonance structure is disposed on the same substrate as the cathode and/or the anode and/or the electron optics.

In one embodiment, the electron source features a target disposed and configured such that the electron beam impinges on the target to generate X-rays. In particular, metallic layers, such as copper, nickel or graphite, are suitable targets. It can be advantageously achieved that characteristic bremsstrahlung in the form of X-rays is generated at the point of impact of the electron beam on the target on a small area, which radiates outward. In one embodiment of the invention, the punctual heat load of the target can be reduced by a pulsed operation or by a temporal variation of the point of impact of the electron beam. For example, the electron beam can be deflected electrostatically for this purpose using one or more deflection plates, for example for scanning the target line by line.

The target preferably features a substrate, which particularly preferably comprises silicon carbide or consists thereof. Particularly preferably, the target is disposed on the same substrate as the cathode and/or the anode and/or the electron optics. In this case, the good thermal conductivity of silicon carbide can be advantageously exploited. The invention is particularly suitable for providing microfocus X-ray sources requiring good focusing of the electron beam. It is also suitable for miniaturized and low-cost X-ray sources for novel applications, in particular in the medical, aerospace and materials research fields.

A preferred electron source comprises power electronic components, for example for driving the cathode, the anode, the electrostatic lens and/or the dielectric resonance structure. The power electronic components are preferably disposed on the same substrate as the cathode, the anode, the electron optics, and/or the dielectric resonant structure. Suitable components are known, for example, from S. Hertel, D. Waldmann, J. Jobst, A. Albert, M. Albrecht, S. Reshanov, A. Schoner, M. Krieger, H. B. Weber, Tailoring the graphene/silicon carbide interface for monolithic wafer-scale electronics, Nature communications, 3 (2012), from S. Hertel, M. Krieger, H. B. Weber, Monolithic circuits with epitaxial graphene/silicon carbide transistors, Physica Status Solidi-Rapid Research Letters, 8 (2014) 688-691, from EP 2535937 B1 and from DE 102011016900 A1.

### BRIEF DESCRIPTION OF THE DRAWINGS

Further advantageous embodiments are described in more detail below with reference to several examples of embodiments shown in the drawings, to which, however, the invention is not limited.

Schematically shown is in:

FIG. 1 the cathode of an electron source according to the invention;

FIG. 2 an electron source according to the invention with the cathode of FIG. 1, in which cathode and anode are disposed on a common substrate;

FIG. 3 the electron source of FIG. 2, further configured so that the graphene layers of the perforated anode of FIG. 2 are opposed by additional graphene layers; and

FIG. 4 an electron source according to the invention with a target for generating X-rays.

### DETAILED DESCRIPTION OF THE EMBODIMENTS OF THE INVENTION

In the following description of preferred embodiments of the present invention, identical reference numbers denote identical or comparable components.

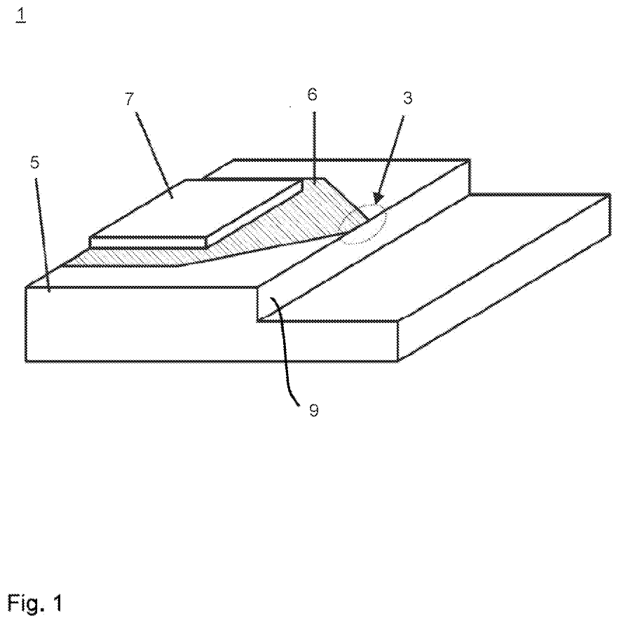

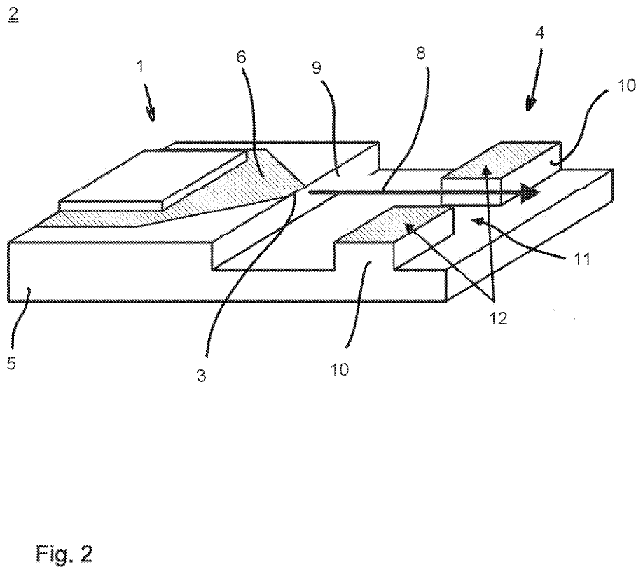

FIG. 1 shows an embodiment of a cathode 1 of the electron source 2 according to the invention. The electron emission comes from an edge 3 of a graphene layer of the cathode 1, which is placed at a high negative potential. The edge 3 of the cathode 1 faces the anode 4 of the electron source 2, as shown in FIG. 2.

The electron source 2 shown in the figures is based on the material system epitaxial graphene on silicon carbide. The starting material is a silicon carbide substrate 5. Due to the material properties, an HPSI (high purity semiinsulating) 4H—SiC, which is commercially available, is particularly suitable. After wet-chemical cleaning of the semiconductor, the pedestal 9 for the emitting edge 3 is lithographically patterned and etched by a dry etching process in a reactive ion etching system (RIE). After another cleaning process, an epitaxial graphene layer 6 is subsequently prepared by thermal decomposition of the silicon carbide surface (silicon side) as known from the above cited paper by K. V. Emtsev et al, Towards wafer-size graphene layers by atmospheric pressure graphitization of silicon carbide, Nat Mater, 8 (2009) 203-207. For this purpose, the sample is heated in a furnace under argon atmosphere close to atmospheric pressure for 30 min to about 1 700° C. In a second lithography step, the graphene area 6 is defined on the pedestal and exposed by an oxygen plasma etching step. Because of this, excess graphene areas are removed. The metal contact 7 to the graphene emitter is realized in a final lithography step by vapor deposition of 5 nm titanium (Ti) and 50 nm gold (Au) followed by a lift-off process.

In an alternative embodiment of the cathode not shown in the figures, the cathode is spatially tapered by using epitaxially defined graphene strips. The graphene strips are a few nanometers wide. In operation, current flow occurs along the graphene strips, and the electrons are emitted from the edge, which is only a few nanometers short.

For preparing the graphene strips, the method described in the above-mentioned paper by M. Sprinkle et al., Scalable templated growth of graphene nanoribbons on SiC, Nature nanotechnology, 5 (2010) 727-731 can be used. Nanofacets are first produced on the (1-10n) crystal surface. This is done either by RIE dry etching of a step followed by an annealing step at about 1 200° C., as suggested by Sprinkle et al. or by a step-bunching process at 1 700° C. for a duration of 30 minutes, the sample being placed in a ceramic silicon carbide container. In a second annealing step without a silicon carbide container, graphene strips are grown on the nanofacets at a slightly lower temperature (approximately 1 400° C. to 1 500° C.). This takes advantage of the fact that graphene growth on these surfaces is faster than on the Si surface of the terraces. Further processing is carried out as described above.

The emitting edge(s) 3 of the cathode 1 shown in the figures or of the last described cathode made of graphene strips may be equipped with one or more carbon nanotubes. The method described in the afore-mentioned paper by J. R. Sanchez-Valencia et al., Controlled synthesis of single-chirality carbon nanotubes, Nature, 512 (2014) 61 is suitable for preparing these nanotubes.

In another alternative embodiment of the cathode not shown in the figures, the cathode is formed as a graphene-graphene tunnel contact or graphene-graphene nanobridge. The inventors have found that a spatially confined electron plasma, which can be used to extract electrons, is formed above the positive electrode of such a tunnel contact or nanobridge. Because of its light emission similar to blackbody radiation at 2 000 K, a corresponding energy dispersion (approximately 200 meV) is to be expected.

For preparing the graphene-graphene tunnel contact, two graphene surfaces are prepared on the pedestal using lithography and oxygen plasma etching in such a way that an only thin graphene channel of a width of approximately 50 nm connects the two graphene surfaces at the pedestal edge. Each graphene surface is contacted with a Ti/Au contact as described above. The thin graphene channel is then opened using an electroburning process so that a gap approximately one to 3 nm wide, also known as a nanogap, is formed. In the electroburning process, a voltage ramp of approximately 0 to 100 V is applied to the two Ti/Au contacts in air. This causes the current through the graphene channel to rise and to heat it up, resulting in a local “burnout” of the graphene channel. This is manifested by a drop in current at which point the voltage ramp is immediately interrupted. By repeating the process, the size of the nanogap can be adjusted via the ohmic resistance.

During operation of the electron source 2, the electrons of the electron beam 8 emitted from the cathode 1 are accelerated towards a perforated anode 4 using an extraction voltage. The simplest embodiment of such a perforated anode 4 is shown in FIG. 2. To produce this anode, both the pedestal 9 for the cathode 1 and an anode bar 10 with the interruption forming a channel 11 of the anode 4 are produced in the same RIE dry etching step. In the subsequent graphene patterning process (lithography and oxygen plasma etching), the graphene layer 12 is left on the anode bar 10 and contacted using Ti/Au contacts (not shown); no additional process step is required for this. To improve the perforated anode properties, the anode bar 10 can also be doped. For this purpose, an implantation mask for the anode bar 10 is defined lithographically prior to the graphene growth process and the latter is doped by ion implantation, for example with nitrogen ions, in such a way that a good conductivity is achieved; a suitable nitrogen concentration is 10¹⁹ cm⁻³. The sample is then covered with a carbon cap, the implantation damage is cured at 1 700° C. for a period of 30 minutes and the doping is activated. The carbon cap is then removed by oxidation in oxygen at 800° C. for a period of 30 minutes and the sample is cleaned again. Further preparation is as described above.

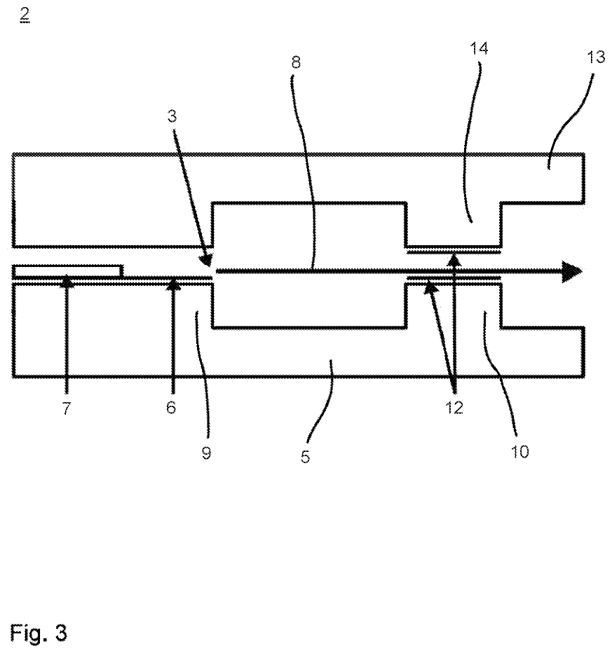

In order to realize a more exact equivalent of a conventional perforated anode, an enclosed structure can be produced by capping the previously described structure. For this purpose, a second silicon carbide substrate 13 is patterned in such a way that a mirror-image anode bar 14 for the upper side is formed, as shown in FIG. 3. This patterning is done using the same process steps as described before for the bottom side, including graphene growth. The two semiconductor wafers are then pressed together and clamped, glued, or bonded together by a wafer bonding process. As a result, the components of the electron source 2 are located inside the chip and are thus additionally protected against external influences. The electron beam 8 exits through the lateral opening of the perforated anode.

In the same way as this perforated anode, a second bar can be made (not shown in the figures) with appropriate contacts, which performs the function of a Wehnelt cylinder for adjusting the electron beam intensity.

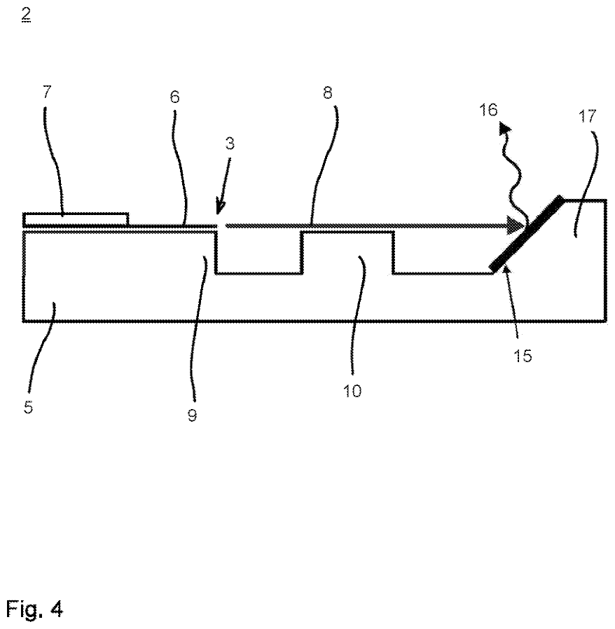

FIG. 4 shows a further development of the electron source 2 shown in FIG. 2, which additionally features a target 15 in order to be able to be used for generating X-rays 16. For the preparation, an opening for the inclined target pedestal 17 is patterned in a further lithography step. This process step should be carried out before the patterning of the cathode pedestal 9 and the anode bar 10. The inclined target area is achieved either by an isotropic RIE dry etching step, i.e. at higher process pressure, by grayscale lithography or by selective electrochemical etching. In the latter method, aluminum is implanted under oblique incidence prior to graphene growth; the electrochemical process selectively removes the aluminum-doped areas. The target metallization is achieved by vapor deposition of metallic layers, for example copper or nickel, through a lithographically defined mask followed by a lift-off process. The metal and layer thickness depend on the specific applications. Typical layer thicknesses are in the range between 10 nm and μm1. The further process steps are carried out as described above.

1. An electron source for generating an electron beam with a cathode, wherein the electron source further comprises a substrate of the cathode featuring silicon carbide.

2. The electron source according to claim 1, wherein the cathode comprises a graphene layer epitaxially grown with the silicon carbide of the substrate.

3. The electron source according to claim 1, wherein the electron source further features an anode.

4. An electron source for generating an electron beam, comprising an anode featuring a graphene layer.

5. The electron source according to claim 3, wherein the anode is disposed on a substrate featuring silicon carbide.

6. The electron source according to claim 3, wherein the cathode and the anode are disposed on the same substrate.

7. The electron source according to claim 3, wherein the anode comprises a second substrate.

8. The electron source according to claim 3, wherein a graphene layer of the cathode is disposed such that electrons are emitted at an edge of the graphene layer of the cathode to be accelerated towards the anode.

9. The electron source according to claim 2, wherein the graphene layer of the cathode is configured as strip.

10. The electron source according to claim 3, wherein the cathode features a graphene-graphene tunnel contact or a graphene-graphene nanobridge which is arranged such as to emit electrons from the surroundings of the graphene-graphene tunnel contact or a graphene-graphene nanobridge to be accelerated towards the anode.

11. The electron source according to claim 1, wherein the cathode comprises a carbon nanotube.

12. The electron source according to claim 1, wherein the electron source features at least one electrostatic lens for focusing the electron beam.

13. The electron source according to claim 1, wherein the electron source features a dielectric resonance structure to accelerate the electrons of the electron beam.

14. The electron source according to claim 1, wherein the electron source comprises a target disposed and configured such that the electron beam impinges on the target to generate X-rays.

15. The electron source according to claim 3, wherein the electron source comprises power electronic components disposed on the same substrate as the cathode and/or the anode.

16. A method for generating an electron beam in which electrons are emitted from a cathode featuring a substrate comprising silicon carbide and/or accelerated towards an anode comprising a graphene layer.
